(19) United States
(12) Patent Application Publication
(10) Pub. No.: US 2023/0342831 A1
(43) Pub. Date: Oct. 26, 2023

(54) MACHINE-LEARNING RECOMMENDATION SYSTEM BASED ON GAME THEORY

(71) Applicant: Oracle Financial Services Software Limited, Mumbai (IN)

(72) Inventors: Mridul Kumar Nath, Bangalore (IN); Kingshuk Bose, South 24 Parganas (IN)

(73) Assignee: Oracle Financial Services Software Limited, Mumbai (IN)

(21) Appl. No.: 17/726,297

(22) Filed: Apr. 21, 2022

(51) Int. Cl. G06Q 30/06; G06Q 30/02

(52) U.S. Cl. CPC G06Q 30/0631; G06Q 30/0282; G06N 20/00

(57) ABSTRACT

A machine-learning recommendation system implemented based on game theory for providing recommendations to a first party based on their requirements while also ensuring the recommendation makes sense to a second party. The system can obtain historical data and train a machine-learning model using the historical data. The training includes playing a game between a first player and a second player. The game is played using a minmax theorem that is evaluated with a loss function comprising a first component that represents error in a prediction of a user and product combination and a second component that represents error in a prediction of a value of a product. The game is played until an equilibrium point has been reached at which a final value corresponding to a product to be recommended is determined and the machine-learning model is adapted to minimize the difference between the final value and ground truth information.

### FIELD

The present disclosure relates generally to a recommendation system, and more particularly, to a machine-learning recommendation system implemented based on game theory for providing recommendations to a first party (e.g., an end user) based on their requirements while also ensuring the recommendation makes sense to a second party (e.g., a stakeholder).

### BACKGROUND

Conventional recommendation systems, sometimes referred as individual recommendation systems, aim to provide information items (products, web pages, services, etc.) for a user based on their profile of interests constructed from past behaviors. However, in recent years, there are an increasing number of scenarios in which the needs of many users in combination are to be taken into consideration rather than individuals. In the scenario such as product recommendation, recommendation systems should evaluate the preferences of all decision makers (e.g., all people in a group looking to watch a move together or take a trip together), and this type of recommendation systems is called a group recommendation system. Group recommendation systems are designed to deal with the problem of satisfying a group of users with potentially conflicting interests. Depending on the targets, group recommendation systems fall into various categories. One is to make recommendations for a given group of users. The common strategies are aggregating individual models into group models and aggregating individual predictions into group predictions. The former strategy generates recommendations for each group member and then combines the recommendation results for the group. The latter strategy first aggregates the profiles of each member into one individual model, then makes recommendations for this model. In recent years, user-based group recommendation systems attract more research in modeling group preference with some new strategies such as treating the recommendation process as a gam.

Games are playing a key role in the evolution of artificial intelligence (AI). For example, game environments are becoming a popular training mechanism in areas such as reinforcement learning or imitation learning. In theory, any multi-agent AI system can be subjected to gamified interactions between its participants. The branch of mathematics that formulates the principles of games is known as game theory. In the context of AI and deep learning systems, game theory is advantageous to enable some of the key capabilities required in multi-agent environments in which different AI programs interact or compete in order to accomplish a goal. Game theory can also be used to describe many situations in our daily life and machine-learning models. For example, a classification algorithm can be explained in terms of a two-player game in which one player is challenging the other to find the best domain space giving them the most difficult points to classify. The game will then converge to a solution which will be a trade-off between the strategic abilities of the two players (e.g., how well the first player was challenging the second one to classify difficult data points and how good was the second player to identify the best decision boundary).

With respect to group recommendation systems, each user is influenced by the decisions of other users. They influence each other, as a result, the decision-making process is like a game among multiple players and the users or players try to achieve an agreement. The final recommendation results can be determined when every user reaches their best decision, that is, the decision set made by users would not be optimal if any of users changes their decision. Such an optimal system state is called Nash Equilibrium in game theory. In this game, each candidate user acts as a player, each user has an action set (consuming or not consuming) and makes decision based on their willingness. The decision set corresponds to the strategy set in game theory, and the recommendation process is modeled as a problem of finding the Nash equilibrium in non-cooperative game theory.

### SUMMARY

Techniques are provided for generating recommendations for a first party based on their requirements while also ensuring the recommendation makes sense to a second party. The recommendations are generated using a machine-learning recommendation system implemented based on game theory. Various embodiments are described herein, including methods, systems, non-transitory computer-readable storage media storing programs, code, or instructions executable by one or more processors, and the like.

In various embodiments, a computer-implemented method if provided that comprises: obtaining historical data comprising user profiles, a list of products and their associated characteristics, and transactional data pertaining to users associated with the user profiles and the products; training a machine-learning model using the historical data, where: the machine-learning model comprises one or more algorithms configured to model a game between a first player and a second player, the first player represents a first party associated with the users and the second player represents a second party associated with a stakeholder in the products, and the training comprises: inputting the historical data into the machine-learning model; playing the game between the first player and the second player, where the game is played using a minmax theorem to minimize a worst-case potential loss that is evaluated with a loss function comprising a first component that represents error in a prediction of a user and product combination and a second component that represents error in a prediction of a value of a product, and the playing comprises performing iteratively the following until an equilibrium point is reached: the first player chooses a strategy for recommending a product that is evaluated based on the loss function, where, for the strategy of the first player, the first player will try to recommend the product based on user choice using a collaborative filtering approach, and the objective of the first player is to minimize an error between the prediction of the user and the product combination and an actual user and product combination; the second player chooses a strategy for recommending a product that is evaluated based on the loss function, where, for the strategy of the second player, the second player will try to recommend a product based on a value that the second party may gain by selling the product, and the objective of the second player is to recommend a higher value product; and determining whether an equilibrium point has been reached; and in response to reaching the equilibrium point, determining a final value corresponding to a product to be recommended for the first party and adapting the machine-learning model to minimize the difference between the final value and ground truth information and obtain a trained machine-learning model; and providing the trained machine-learning model.

In some embodiments, the adapting the machine-learning model comprises updating model parameters of the machine-learning model.

In some embodiments, the providing comprises deploying the trained machine-learning model with the updated model parameters in a real-world environment.

In some embodiments, the method further comprises: receiving a user profile of a first party and a list of products and their characteristics associated with a second party; inputting the user profile and the list of products and their characteristics into the trained machine-learning model; predicting, by the trained machine-learning model, a product to be recommend for the first party based on the user profile and the list of products and their characteristics; and recommending the product to the first party.

In some embodiments, the collaborative filtering approach comprises: mapping the transactional data to implicit ratings for the products using an algorithm; and inputting the historical data and the implicit ratings into a collaborative filter, which uses similarities between the users and the products to provide recommendations.

In some embodiments, the collaborative filtering is performed on the loss function using a matrix factorization first party vector and a matrix factorization product vector, and the loss function calculates the error between the prediction of the user and the product combination and the actual user and product combination from the matrix factorization.

In some embodiments, the loss function is:

$${l}_{0} = {\sum }_{{u}_{i} ∈ S} {( {r}_{{u}_{i}} - {x}_{u}^{T} )}^{2} + {λ}_{x} {\sum }_{u} {‖ {x}_{u} ‖}^{2} + {λ}_{y} {\sum }_{u} {‖ {y}_{i} ‖}^{2} - \frac{{λ}_{c}}{2} {\sum }_{i} {‖ {C}_{i} ‖}^{2}$$

where the rᵤᵢ is the rating of the first party u along with corresponding product i, xᵤ is the matrix factorization first party vector, yᵢ is the matrix factorization product vector, λₓ, λ_{y} is regularization parameters, the Cᵢ is the value that the second party may gain by selling the corresponding product i, λ_{c} is a regularization coefficient.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein.

Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments in accordance with the present disclosure will be described with reference to the drawings, in which:

FIG. 1 depicts a block diagram illustrating a machine-learning recommendation system in accordance with various embodiments.

FIG. 2 depicts a block diagram illustrating the application of game theory to solve a prediction model in accordance with various embodiments.

FIG. 3 depicts a flowchart illustrating a process for training a machine-learning model and using the trained machine-learning model to recommend a product in accordance with various embodiments.

FIG. 4 depicts a simplified diagram of a distributed system for implementing various embodiments.

FIG. 5 is a simplified block diagram of one or more components of a system environment by which services provided by one or more components of an embodiment system may be offered as cloud services, in accordance with various embodiments.

FIG. 6 illustrates an example computer system that may be used to implement various embodiments.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### Introduction

Product recommendations and their various manifestations have been popular and effective strategies for broadening market reach while increasing customer engagement. For example, machine-learning driven recommendation systems have been used in retail industries including the banking industry to recommend products for cross-selling and up-selling based on historical choice patterns of cohorts. The machine-learning solutions typically involve use of collaborative filtering, also known as item based collaborative filtering or IBCF, and matrix factorization based methods using content filtering. While the collaborative filtering approach depends on an explicit scoring mechanism based on user recommendations, e.g., 3 out of 5 stars for a movie rated by a user, content-based filtering is based on trying to guess the features or behavior of a user given the item's features, he/she reacts positively to, e.g., in case of a movie, the features could be action film, Oscar winning actors, director, etc.

These strategies have proven effective to retain user (e.g., customers), but the enterprise (e.g., a bank or other merchants) offering a product may not gain respective monetary value from selling products when measuring ROI (return on investment) or analyzing fiscal benefits. This is because conventional individual recommendation systems limit themselves to solely taking user preferences into consideration. In most cases, recommended products do not add any significant financial benefit or advantages to the enterprise offering the product (e.g., a bank or other merchants). The conventional way the enterprises have attempted to circumvent this issue is to recommend products based on higher value (e.g., business or monetary value) by using naive filters on existing recommendations to the users. However, filtering approaches on existing recommendations typically results in a lower success rate of user satisfaction with their purchases.

To overcome these challenges and others, the techniques described herein are directed to generating recommendations (e.g., recommendations on products or services) for a first party (e.g., an end user) based on their requirements while also ensuring the recommendation makes sense (e.g., business sense) to a second party (e.g., a stakeholder). The recommendations are generated using a machine-learning recommendation system implemented based on game theory, which formulates the principles of a game between n players (also known as decision makers). While the game can be played with n players, in this disclosure the game is described with respect to only two players (e.g., a first player representing the interests of the first party such as a user or customer and a second player representing the interest of a second party such as an enterprise or organization) for simplification and clarity of the detailed description. In this approach with the help of game theory, the machine-learning recommendation system attempts to make recommendations, which are aligned to the requirements of a first party while still making sense to a second party seeking one or more benefits/advantages from the recommendations. The first player will try to make recommendations (e.g., recommend a product) based on user choice (e.g., based on preferences of the first player) using a collaborative filtering approach. The objective of the first player will be to minimize the error between predicted and actual ratings, which should maximize satisfaction of the first party. The second player on the other hand will try to make recommendations (e.g., recommend products) based on one or more benefits/advantages (e.g., the monetary value) that the second party may gain from the recommendations. The objective of second player will be to maximize the one or more benefits/advantages for the second party. There will be a simulated game/competition between the two players and the attempted goal will be to find an equilibrium point which will represent the optimization between the two objectives.

In an exemplary embodiment, a technique implemented by a computing system for generating recommendations includes: obtaining historical data comprising user profiles, a list of products and their associated characteristics, and transactional data pertaining to users associated with the user profiles and the products; and training a machine-learning model using the historical data, where: the machine-learning model comprises one or more algorithms configured to model a game between a first player and a second player, the first player represents a first party associated with the users and the second player represents a second party associated with a stakeholder in the products. The training comprises: inputting the historical data into the machine-learning model; and playing the game between the first player and the second player, where the game is played using a minmax theorem to minimize a worst-case potential loss that is evaluated with a loss function comprising a first component that represents error in a prediction of a user and product combination and a second component that represents error in a prediction of a value of a product. The playing comprises performing iteratively the following until an equilibrium point is reached: the first player chooses a strategy for recommending a product that is evaluated based on the loss function, where, for the strategy of the first player, the first player will try to recommend the product based on user choice using a collaborative filtering approach, and the objective of the first player is to minimize an error between the prediction of the user and the product combination and an actual user and product combination; the second player chooses a strategy for recommending a product that is evaluated based on the loss function, where, for the strategy of the second player, the second player will try to recommend a product based on a value that the second party may gain by selling the product, and the objective of the second player is to recommend a higher value product; and determining whether an equilibrium point has been reached. The training further comprises in response to reaching the equilibrium point, determining a final value corresponding to a product to be recommended for the first party and adapting the machine-learning model to minimize the difference between the final value and ground truth information and obtain a trained machine-learning model. The trained machine-learning model is then provided, e.g., deployed in a real-world environment such as a distributed system.

The training of the machine-learning model based on game theory results in improved speed in the training, increased processing speed during deployment, and ultimately an increase in the accuracy of recommended products. For example, the identification, via the training process, of salient model parameters, features or thresholds that are more important to decision making than others improve the processing speed and reduces network latency of the computing system in a distributed environment. Further, the training of the machine-learning model based on game theory provides a computing system with the ability to perform a function (recommend products to a first party based on their requirements while also ensuring the recommendation makes sense to a second party) it could not previously perform. More specifically, the use of game theoretic concepts in the design of the machine-learning model allows for the computing system to tackle scenarios or problem with imperfect knowledge (e.g., a problem pertaining to recommending a product for a group of individuals with competing goals and unknown strategies). Additionally, this allows for computing system to extend beyond a monolith model-based system and expand to multiple coordinating (or competing) systems of algorithms and/or models where a closed form loss function is not required, and instead the computing system finds an equilibrium to a two-player non-cooperative game while discovering its own loss function.

Advantageously, the machine-learning recommendation system implemented based on game theory makes recommendations that maximize the one or more benefits/advantages for the second party with a greater success rate when compared with the conventional approaches such as using naïve filtering on existing recommendation, and thus offers a better outcome from the perspective of the second party while still satisfying the requirements of the first party. By making more beneficial recommendations from the perspective of the second party (e.g., products with a higher margin), the first party will be more apt to accept recommendations that make sense to the second party more often than is currently realized, which will ultimately result in the satisfaction of the objectives of both parties.

### Machine-Learning Recommendation System and Techniques Thereof

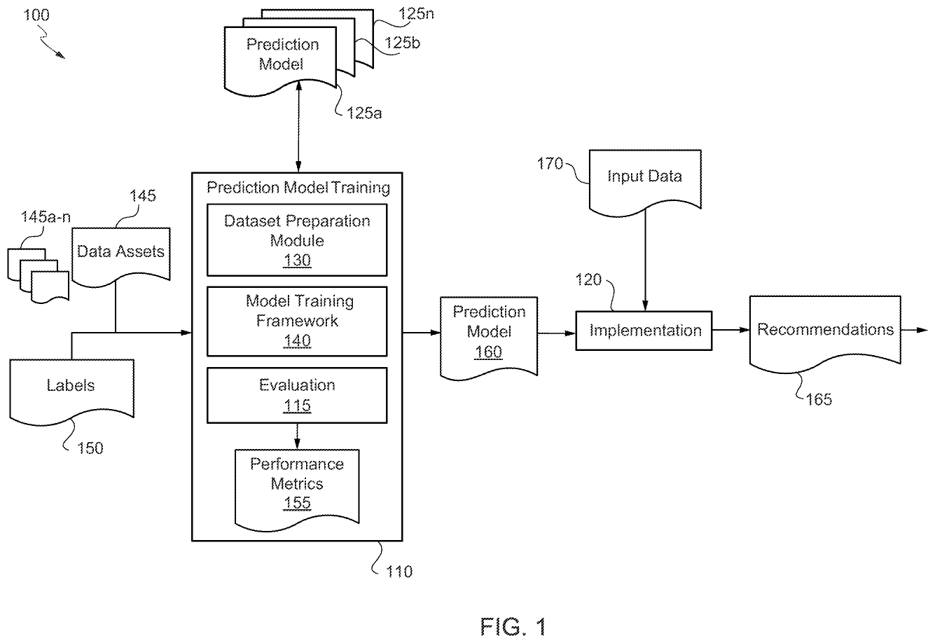

FIG. 1 is a block diagram illustrating a machine-learning recommendation system 100 in accordance with various embodiments. As shown in FIG. 1, the machine-learning recommendation system 100 includes various stages: a prediction model training stage 110 to build and train models, an evaluation stage 115 to evaluate performance of trained models, and an implementation stage 120 for implementing one or more models. The prediction model training stage 110 builds and trains one or more prediction models 125a-125n (‘n’ represents any natural number) to be used by the other stages (which may be referred to herein individually as a prediction model 125 or collectively as the prediction models 125). For example, the prediction models 125 can include a model for recommending to a first party (e.g., a customer) a most relevant product offered by a second party (e.g., a merchant), a model for recommending to a first party (e.g., a customer) a highest value product offered by a second party (e.g., a merchant), and a model for recommending to a first party (e.g., a customer) a most relevant and highest value product offered by a second party (e.g., a merchant). Still other types of prediction models may be implemented in other examples according to this disclosure.

A prediction model 125 can be a machine-learning (“ML”) model, such as a convolutional neural network (“CNN”), e.g., an inception neural network, a residual neural network (“Resnet”), or a recurrent neural network, e.g., long short-term memory (“LSTM”) models or gated recurrent units (“GRUs”) models, other variants of Deep Neural Networks (“DNN”) (e.g., a multi-label n-binary DNN classifier or multi-class DNN classifier). A prediction model 125 can also be any other suitable ML model trained for providing a recommendation, such as a Generative adversarial network (GAN), Naive Bayes Classifier, Linear Classifier, Support Vector Machine, Bagging Models such as Random Forest Model, Boosting Models, Shallow Neural Networks, or combinations of one or more of such techniques—e.g., CNN-HMM or MCNN (Multi-Scale Convolutional Neural Network). The computing environment 100 may employ the same type of prediction model or different types of prediction models for providing recommendations to users. Still other types of prediction models may be implemented in other examples according to this disclosure.

To train the various prediction models 125, the training stage 110 is comprised of two main components: dataset preparation module 130 and model training framework 140. The dataset preparation module 130 performs the processes of loading data assets 145, splitting the data assets 145 into training and validation sets 145a-n so that the system can train and test the prediction models 125, and pre-processing of data assets 145. The splitting the data assets 145 into training and validation sets 145a-n may be performed randomly (e.g., a 90/10% or 70/30%) or the splitting may be performed in accordance with a more complex validation technique such as K-Fold Cross-Validation, Leave-one-out Cross-Validation, Leave-one-group-out Cross-Validation, Nested Cross-Validation, or the like to minimize sampling bias and overfitting.

The training data 145a may include at least a subset of historical data about first parties (e.g., customers) and products offered by a second party (e.g., enterprises banks or other merchants). The historical data can be obtained in various ways including image or text. The historical data can be transactional data, customer profiles, products, and product characteristics. For example, if the historical data is provided as images of transactions, the data preparation 130 may convert the images to text using an image-to-text converter (not shown) that performs text recognition (e.g., optical character recognition) to determine the text within the image. Additionally or alternatively, the data preparation module 130 may standardize the format of the historical data. In some instances, the historical data is provided by the second party or a third party. The training data 145a for a prediction model 125 may include the historical data and labels 150 corresponding to the historical data as a matrix or table of values. For example, for each customer and product, actual user and product combination, an actual value of the product, and an indication of the correct recommendation to be inferred by the prediction model 125 may be provided as ground truth information for labels 150. The behavior of the prediction model 125 can then be adapted (e.g., through MinMax or Alternating Least Square optimization or Gradient Descent) to minimize the difference between the generated inferences for various entities and the ground truth information.

The model training framework 140 performs the processes of determining hyperparameters for the model 125 and performing iterative operations of inputting examples from the training data 145a into the model 125 to find a set of model parameters (e.g., weights and/or biases) that minimizes a cost function(s) such as loss or error function for the model 125. The hyperparameters are settings that can be tuned or optimized to control the behavior of the model 125. Most models explicitly define hyperparameters that control different features of the models such as memory or cost of execution. However, additional hyperparameters may be defined to adapt the model 125 to a specific scenario. For example, the hyperparameters may include regularization weight or strength. The cost function can be constructed to measure the difference between the outputs inferred using the models 145 and the ground truth annotated to the samples using the labels. For example, for a supervised learning-based model, the goal of the training is to learn a function “h( )” (also sometimes referred to as the hypothesis function) that maps the training input space X to the target value space Y, h: X→Y, such that h(x) is a good predictor for the corresponding value of y. Various different techniques may be used to learn this hypothesis function. In some techniques, as part of deriving the hypothesis function, the cost or loss function may be defined that measures the difference between the ground truth value for an input and the predicted value for that input. As part of training, techniques such as back propagation, random feedback, Direct Feedback Alignment (DFA), Indirect Feedback Alignment (IFA), Hebbian learning, and the like are used to minimize this cost or loss function.

Once the set of model parameters are identified, the model 125 has been trained and the model training framework 140 performs the additional processes of testing or validation using the subset of testing data 145b (testing or validation data set). The testing or validation processes includes iterative operations of inputting examples from the subset of testing data 145b into the model 125 using a validation technique such as K-Fold Cross-Validation, Leave-one-out Cross-Validation, Leave-one-group-out Cross-Validation, Nested Cross-Validation, or the like to tune the hyperparameters and ultimately find the optimal set of hyperparameters. Once the optimal set of hyperparameters are obtained, a reserved test set from the subset of test data 145b may be input into the model 125 to obtain output (in this example, one or more recognized entities), and the output is evaluated versus ground truth entities using correlation techniques such as Bland-Altman method and the Spearman's rank correlation coefficients. Further, performance metrics 155 may be calculated in evaluation stage 115 such as the error, accuracy, precision, recall, receiver operating characteristic curve (ROC), etc. The metrics 155 may be used in the evaluation stage 115 to analyze performance of the model 125 for providing recommendations.

The model training stage 110 outputs trained models including one or more trained recommendation models 160. The one or more trained recommendation models 155 may be deployed and used in the implementation stage 120 for providing recommendations 165 to users. For example, recommendation models 160 may receive input data 170 including a customer profile, a list of products, and product characteristics from a second party for a first party and provide recommendations 165 to the first party based on their requirements while also ensuring the recommendation makes sense to the second party.

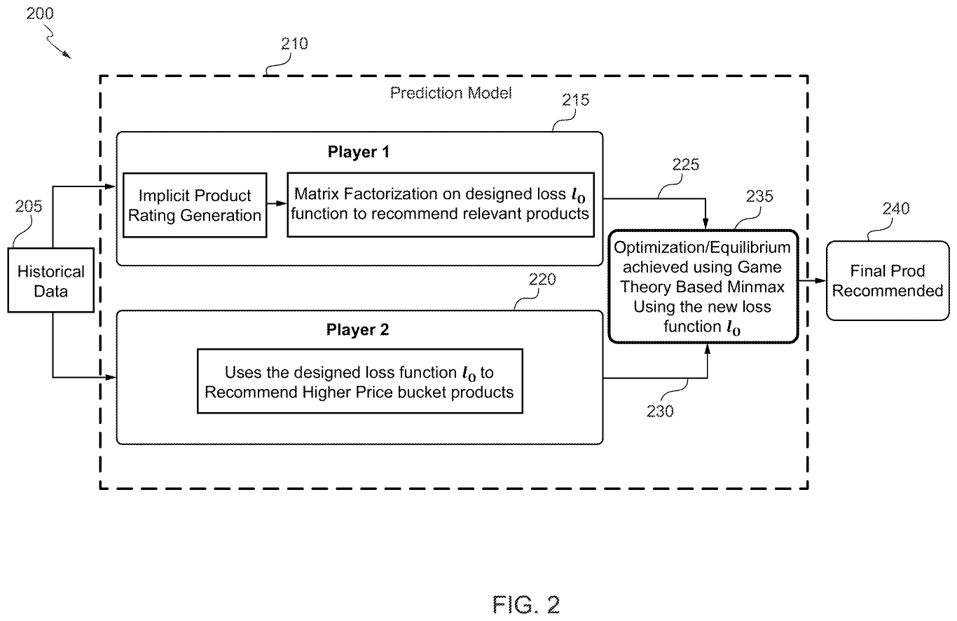

FIG. 2 is a block diagram illustrating the application of game theory to solve a prediction model (e.g., one or more models 125) in accordance with various embodiments. At block 205, a set of training data is obtained (e.g., obtained as described with respect to training stage 110) for training the prediction model 210 to recommend products to a user. The set of training data comprises historical data about first parties (e.g., end users such as customers) and products or services offered by a second party (e.g., stakeholders such as banks or other merchants). In some instances, the historical data is obtained from the second party. The historical data may include transactional data, profile of customers, products, and characteristics of products. In some examples, transactional data can be information gathered from transactions taking place between the first parties and the second party. Specifically, the transactional data record information can include the time and location of the transaction, the quantity and quality of the products purchased, the prices of the products purchased, indication of whether any discounts were given, and the method used to pay for the purchases. In some examples, the profiles of the first parties may include detailed descriptions of current and past first parties. The profiles of the first parties can also be used to identify first parties' purchasing behaviors, pain points, psychographics, and demographics for marketing to similar first parties in the future. The product data is a list of products available for consumption. A product is typically a tangible or intangible item that is put on the market for acquisition, attention, or consumption, while a service is an intangible item, which arises from the output of one or more individuals. Although products and service are different offerings, “product” or “products” as used herein is to be interpreted as being directed to a product, a service, or a combination thereof. From the product perspective of the historical data, the characteristics of products can include frequency of the product being ordered, types of products, costs, and prices of products, the monetary value of products, minimum and maximum duration or quantity of products, and rating information of products from current and past customers.

The prediction model 210 comprises one or more algorithms implemented based on game theory and configured to balance the preferences of the first party with the interests of the second party such that a predicted recommendation satisfies the requirements of the first party while making sense to the second party. The one or more algorithms may be developed depending on game theory for various types of learning problems. For example, the one or more algorithms could be developed for neural learning. Game-theoretic concepts like the Shapley value help to differentiate significantly from unnecessary elements of an artificial neural network. A non-cooperative game may be designed from a neural network where neurons that form different groups and their contributions to the game are determined with the help of the Shapley value. Alternatively, the one or more algorithms could be developed for adversarial learning. Game-theoretic concepts like the Nash Equilibrium may be used to assist two models (e.g., a GAN comprising a generative model representing the first player 215 and a discriminative model representing the second player 220) to become proficient at performing their tasks until the models are not able to improve anymore. Alternatively, the one or more algorithms could be developed for reinforcement learning. Game-theoretic concepts like the Nash Equilibrium may be used to assist two agents (e.g., two models) learn and achieve an equilibrium point through interactions with one another and an environment. Alternatively, the one or more algorithms could be developed for adversarial learning. Game-theoretic concepts like a non-cooperative two-player game can be set-up, where there must be a value and exist an equilibrium point for both the players (learned via a minmax theorem). The equilibrium point can be determined by applying pure or mixed strategies by either one or both the players. For example, assume that x and y are strategies of two players (the first player 215 and the second player 220) and v is the value of the game. Then, the minimax theorem can be formulated as that x and y are strategies of two players and v is the value of the game. Then, the minimax theorem can be formulated as x∈X, y∈Y maxmin f(x,y)=y∈Y, x∈X minmax f(x,y)=v. As should be understood, there are several different machine-learning models that could be implemented based on one or more game-theoretic concepts.

In various embodiments, the game theory approach uses two players where the first player 215 will try to recommend a product based on the first party choice using a collaborative filtering approach. The objective of the first player 215 will be to minimize the error between the prediction of the user and the product combination and an actual user and product combination based on predicted and actual ratings for the product (the ratings determining relevancy of the product to a given party). The second player 220 on the other hand will try and recommend products based on a value that the second party may gain by offering the product. The objective of the second player 220 will be to maximize the value for the second party by recommending higher value products, while safeguarding the interest of the first party. Higher value meaning a product of higher value from the perspective of the second party, whether that perspective is a business value, a monetary value, or the like. Thus, the learning problem for model 210 is converted into an optimization problem, a loss function l₀ is defined, and the training optimizes model parameters of the one or more algorithms to minimize the loss function. The defined loss function l₀ comprises two components. The first component is identified as l₁ (Equation 1) to represent the error in prediction of a relevant product for the first party (takes into consideration the combination of preferences of the first party and product characteristics). The first player 215 of the game is used to find the optimal combination of xᵤ (user) and y₁ (product), which will minimize the loss function l₁.

$${l}_{1} = {\sum }_{{u}_{i} ∈ S} {( {r}_{{u}_{i}} - {x}_{u}^{T} )}^{2} + {λ}_{x} {\sum }_{u} {‖ {x}_{u} ‖}^{2} + {λ}_{y} {\sum }_{u} {‖ {y}_{i} ‖}^{2} \qquad ( 1 )$$

where the rᵤᵢ is the rating of the first party u along with corresponding product i, xᵤ is the matrix factorization first party vector, yᵢ is the matrix factorization product vector, λₓ, λ_{y} is the regularization parameters. The second component is identified as l₂ (Equation 2) to represent the error in prediction of a product that satisfies one or more interests of the second party (e.g., maximize total price or return on investment of the product). The second player 220 of the game is used to find the optimal value Cᵢ for the interest of the second party, which will minimize the loss function l₂.

$${l}_{2} = \frac{{λ}_{c}}{2} {\sum }_{i} {‖ {C}_{i} ‖}^{2} \qquad ( 2 )$$

where the Cᵢ is the interest of the second party (e.g., cost of product or product price), λ_{c} is the regularization coefficient. The Game theory approach will attempt to gain equilibrium using loss function l₁ and l₂ and recommend the product. The minimization of the final loss function l₀=l₁+l₂, (Equation 3) by both the first player 215 and the second player 220, can also be approached as a Lagrange multiplier, ensures a higher prediction precision and good recall. In other words, the prediction model 210 will be trained to recommend products, which are relevant to the first party and still attempt to maximize the interest of the second party (e.g., attempt to increase the total price of the product, to yield a greater financial benefit by recommending higher bucketed products).

$${l}_{0} = {\sum }_{{u}_{i} ∈ S} {( {r}_{{u}_{i}} - {x}_{u}^{T} )}^{2} + {λ}_{x} {\sum }_{u} {‖ {x}_{u} ‖}^{2} + {λ}_{y} {\sum }_{u} {‖ {y}_{i} ‖}^{2} - \frac{{λ}_{c}}{2} {\sum }_{i} {‖ {C}_{i} ‖}^{2} \qquad ( 3 )$$

where the rᵤᵢ is the rating of first party u along with corresponding product i, xᵤ is matrix factorization first party vector, yᵢ is the matrix factorization product vector, λₓ, λ_{y} is the regularization parameters, the Cᵢ is the interest of the second party (e.g., cost of product or product price), λ_{c} is the regularization coefficient.

As shown in FIG. 2, the first player 215 is configured to strategize and determine a first set of recommended products 225 for a first party. Specifically, the first player 215 takes as input the historical data, generates an implicit rating for products, and performs a collaborative filtering on the final loss function l₀ to recommend relevant products 225 for the first party. The basic input for a collaborative filter is user ratings on products. However, explicit ratings by users are not always available in the historical data. Even when the explicit ratings are available it is generally biased. Nonetheless, transaction data that illustrates user interactions with the products reflect the level of satisfaction or preference that users have for various products. Based on this understanding, it's possible for the first player to map the transaction data to implicit ratings for the products using an algorithm such as a heuristic algorithm. The first player then inputs the historical data and implicit product ratings into a collaborative filter, which uses similarities between users and products to provide recommendations. For example, matrix factorization is a class of collaborative filtering (i.e., the collaborative filter algorithm), which can look for similar parties in the historical data to that of the first party, similar products in the historical data to that of the products that could be offered to the first party, or a combination thereof to provide recommendations. The collaborative filtering is performed on the final loss function l₀ using xᵤ as the matrix factorization first party vector and yᵢ as the matrix factorization product vector, and the final loss function l₀ calculates the error in the predicted recommendation from the matrix factorization. Accordingly, the strategy of the first player is being used to train the model 210 so that a result of high-level user satisfaction is expected to be gained from the first recommended products. In other words, the model 210 is trained to find out the products that are most coherent to the preference of certain first parties according to historical data.

The second player 220 is configured to strategize and determine a second set of recommended products 230 for a first party. Specifically, the second player 220 takes as input the historical data and uses the final loss function l₀ to recommend products 230 for the first party that are of interest (e.g., high value) to the second party. As discussed herein, the products that are most relevant to the first party may not be the same as the products with the best value for the second party. Therefore, to balance these potentially conflicting goals, the strategy of the second player 220 is being used to train the model 210 so that a result of high-level value is expected to be gained by selling the second recommended product 230. In other words, the model 210 is trained to infer the products that are most coherent to the interest to the second party (e.g., higher price bucket products) according to historical data.

At block 235, the model uses a non-cooperative two-player game between the first player 215 and the second player 220, where there is a final value 240 (recommended product) that exists at an equilibrium point for both the players that is learned via a minmax algorithm and the final loss function l₀. In this instance, the first player 215 may be thought of as the minimizer and the second player 220 may be thought of as the maximizer. However, it should be understood that the game could conceivable be set up such that the first player 215 may be thought of as the maximizer and the second player 220 may be thought of as the minimizer. Alternatively, a different game theory approach may be taken such as the use of a Shapley value or Nash Equilibrium as described herein. In a first step, the algorithm generates a game-tree and applies an evaluation function (e.g., the final loss function l₀) to obtain the utility values for the terminal states. Suppose the second player 220 takes a first turn in the game, which determines a product that has worst-case initial value=−∞, and the first player 215 takes a next turn which determines a product that has a worst-case initial value=+∞. Now, the utility values for the second player 220 are determined, and its initial value may be −∞, so each value in the terminal state is compared with initial value of the second player 220 and the higher node values are determined. The minmax algorithm will find the maximum among all the higher nodes values. In the next step, it's a turn for the first player 215, so the minmax algorithm will compare all nodes value with +∞ and will find the third layer node values. Now it's a turn for the second player 220, and the minmax algorithm will again choose the maximum of all node values and find the maximum value for the root node. In this game tree, only four layers are explained, thus the root node is reached quickly, however it should be understood in a real implementation the first player and second player would go back and forth until the maximum value for the root node is determined (likely greater than four layers). The maximum value for the root node at depth 0 is then output as the final value 240 for a recommended product. The final value 240 may be provided as a recommendation to the first party, which should satisfy their requirements while also making sense to the second party.

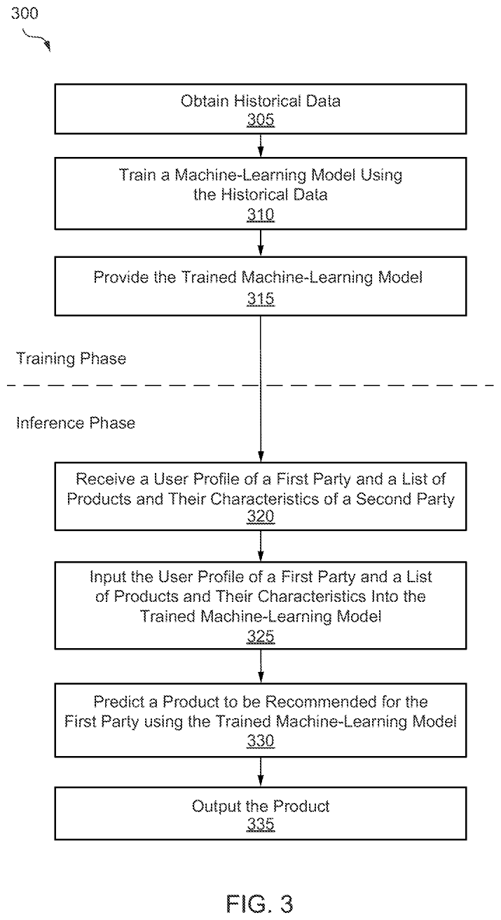

FIG. 3 is a flowchart illustrating a process 300 for training a machine-learning model and using the trained machine-learning model to recommend a product in accordance with various embodiments. The process 300 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process 300 presented in FIG. 3 and described below is intended to be illustrative and non-limiting. Although FIG. 3 depicts the various processing steps occurring in a particular sequence or order, this is not intended to be limiting. In certain alternative embodiments, the steps may be performed in some different order, or some steps may also be performed in parallel. In certain embodiments, such as in the embodiments depicted in FIGS. 1 and 2, the processing depicted in FIG. 3 may be performed by a computing environment (e.g., computing environment 100) using a prediction model (e.g., prediction model 210) to generate recommendations for a first party.

At step 305, historical data is obtained. The historical data comprises user profiles, a list of products and their associated characteristics, and transactional data pertaining to users associated with the user profiles and the products.

At step 310, a machine-learning model is trained using the historical data. The machine-learning model comprises one or more algorithms configured to model a game between a first player and a second player, the first player represents a first party associated with the users and the second player represents a second party associated with a stakeholder in the products.

The training comprises inputting the historical data into the machine-learning model and playing the game between the first player and the second player. The game is played using a minmax theorem to minimize a worst-case potential loss that is evaluated with a loss function comprising a first component that represents error in a prediction of a user and product combination and a second component that represents error in a prediction of a value of a product

The playing the game comprises performing iteratively the following until an equilibrium point is reached: (i) the first player chooses a strategy for recommending a product that is evaluated based on the loss function, where, for the strategy of the first player, the first player will try to recommend the product based on user choice using a collaborative filtering approach, and the objective of the first player is to minimize an error between the prediction of the user and the product combination and an actual user and product combination; (ii) the second player chooses a strategy for recommending a product that is evaluated based on the loss function, where, for the strategy of the second player, the second player will try to recommend a product based a value that the second party may gain by selling the product, and the objective of the second player is recommending higher value products, and (iii) determining whether an equilibrium point has been reached.

The collaborative filtering approach comprises mapping the transactional data to implicit ratings for the products using an algorithm; and inputting the historical data and the implicit ratings into a collaborative filter, which uses similarities between the users and the products to provide recommendations. The collaborative filtering is performed on the loss function using a matrix factorization first party vector and a matrix factorization product vector, and the loss function calculates the error between the prediction of the user and the product combination and the actual user and product combination from the matrix factorization. The loss function is:

$${l}_{0} = {\sum }_{{u}_{i} ∈ S} {( {r}_{{u}_{i}} - {x}_{u}^{T} )}^{2} + {λ}_{x} {\sum }_{u} {‖ {x}_{u} ‖}^{2} + {λ}_{y} {\sum }_{u} {‖ {y}_{i} ‖}^{2} - \frac{{λ}_{c}}{2} {\sum }_{i} {‖ {C}_{i} ‖}^{2} \qquad ( 3 )$$

where the rᵤᵢ is the rating of the first party u along with corresponding product i, xᵤ is the matrix factorization first party vector, yᵢ is the matrix factorization product vector, λₓ, λ_{y} is regularization parameters, the Cᵢ is the value that the second party may gain by selling the corresponding product i, λ_{c} is a regularization coefficient.

The training further comprises in response to reaching the equilibrium point, determining a final value corresponding to a product to be recommended for the first party and adapting the machine-learning model to minimize the difference between the final value and ground truth information and obtain a trained machine-learning model. The adapting the machine-learning model comprises updating model parameters of the machine-learning model.

At step 315, the trained machine-learning model is provided. In some instances, the providing comprises deploying the trained machine-learning model with the updated model parameters in a real-world environment (e.g., a distributed system as described in detail herein).

At step 320, a user profile of a first party and a list of products and their characteristics associated with a second party are received. For example, while the trained machine-learning model is deployed in a real-world environment, the computing system may receive new data (a user profile of a first party and a list of products and their characteristics associated with a second party) as part of a product recommendation task or subtask.

At step 325, the user profile and the list of products and their characteristics are input into the trained machine-learning model.

At step 330, a product to be recommend for the first party is predicted by the trained machine learning model based on the user profile and the list of products and their characteristics.

At step 335, the product is output. For example, the product may be displayed or transmitted to another device. In some instances, the product is recommended to the first party.

### Illustrative Systems

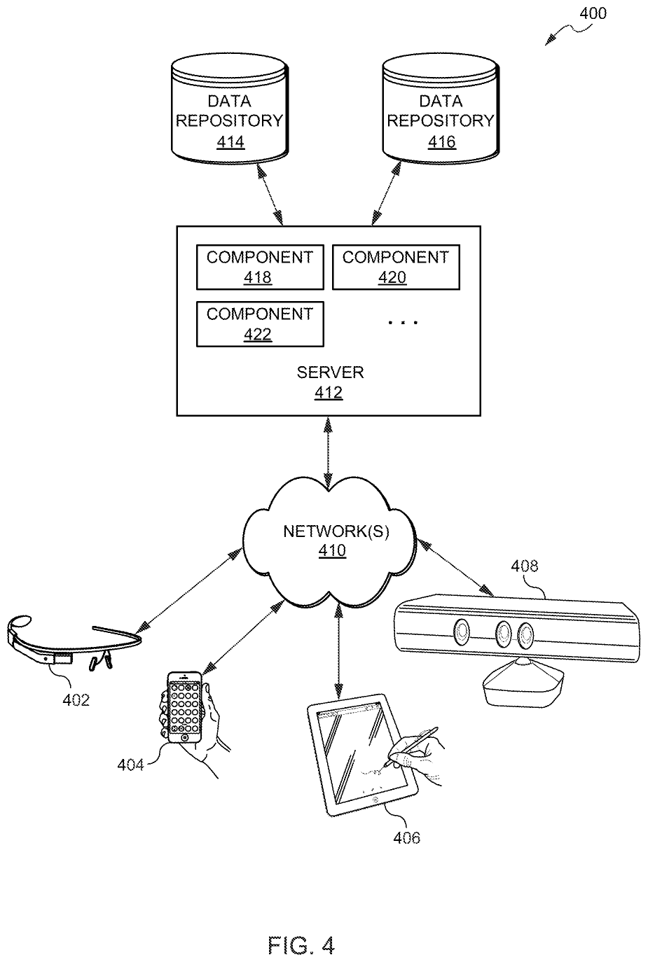

FIG. 4 depicts a simplified diagram of a distributed system 400. In the illustrated example, distributed system 400 includes one or more client computing devices 402, 404, 406, and 408, coupled to a server 412 via one or more communication networks 410. Clients computing devices 402, 404, 406, and 408 may be configured to execute one or more applications.

In various examples, server 412 may be adapted to run one or more services or software applications that enable one or more embodiments described in this disclosure. In certain examples, server 412 may also provide other services or software applications that may include non-virtual and virtual environments. In some examples, these services may be offered as web-based or cloud services, such as under a Software as a Service (SaaS) model to the users of client computing devices 402, 404, 406, and/or 408. Users operating client computing devices 402, 404, 406, and/or 408 may in turn utilize one or more client applications to interact with server 412 to utilize the services provided by these components.

In the configuration depicted in FIG. 4, server 412 may include one or more components 418, 420 and 422 that implement the functions performed by server 412. These components may include software components that may be executed by one or more processors, hardware components, or combinations thereof. It should be appreciated that various different system configurations are possible, which may be different from distributed system 400. The example shown in FIG. 4 is thus one example of a distributed system for implementing an example system and is not intended to be limiting.

Users may use client computing devices 402, 404, 406, and/or 408 to execute one or more applications, models or chatbots, which may generate one or more events or models that may then be implemented or serviced in accordance with the teachings of this disclosure. A client device may provide an interface that enables a user of the client device to interact with the client device. The client device may also output information to the user via this interface. Although FIG. 4 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 410 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 410 may be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 412 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 412 may include one or more virtual machines running virtual operating systems, or other computing architectures involving virtualization such as one or more flexible pools of logical storage devices that may be virtualized to maintain virtual storage devices for the server. In various examples, server 412 may be adapted to run one or more services or software applications that provide the functionality described in the foregoing disclosure.

The computing systems in server 412 may run one or more operating systems including any of those discussed above, as well as any commercially available server operating system. Server 412 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 412 may include one or more applications to analyze and consolidate data feeds and/or event updates received from users of client computing devices 402, 404, 406, and 408. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 412 may also include one or more applications to display the data feeds and/or real-time events via one or more display devices of client computing devices 402, 404, 406, and 408.

Distributed system 400 may also include one or more data repositories 414, 416. These data repositories may be used to store data and other information in certain examples. For example, one or more of the data repositories 414, 416 may be used to store information such as information related to machine-learning model performance or generated machine-learning model for use by server 412 when performing various functions in accordance with various embodiments. Data repositories 414, 416 may reside in a variety of locations. For example, a data repository used by server 412 may be local to server 412 or may be remote from server 412 and in communication with server 412 via a network-based or dedicated connection. Data repositories 414, 416 may be of different types. In certain examples, a data repository used by server 412 may be a database, for example, a relational database, such as databases provided by Oracle Corporation® and other vendors. One or more of these databases may be adapted to enable storage, update, and retrieval of data to and from the database in response to SQL-formatted commands.

In certain examples, one or more of data repositories 414, 416 may also be used by applications to store application data. The data repositories used by applications may be of different types such as, for example, a key-value store repository, an object store repository, or a general storage repository supported by a file system.

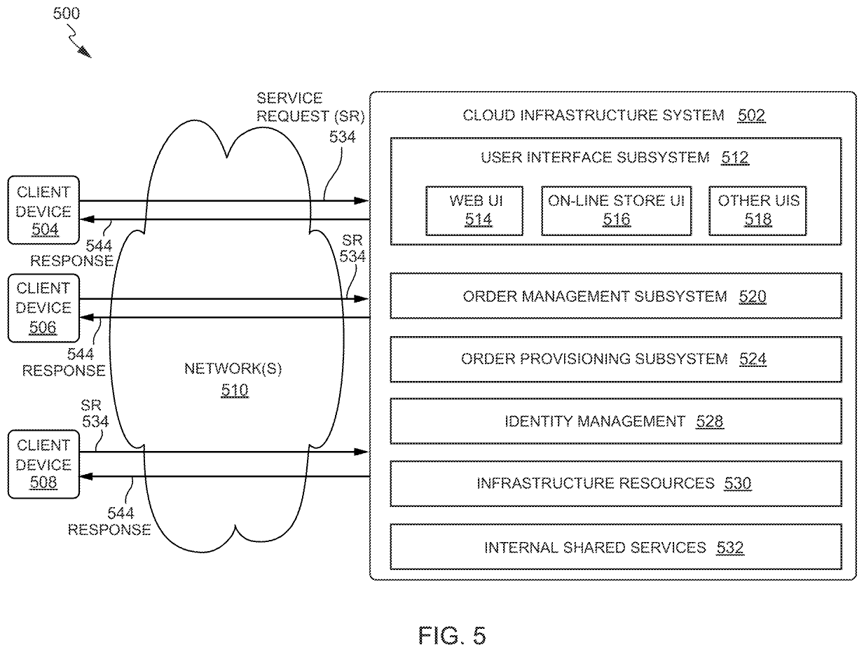

In certain examples, the functionalities described in this disclosure may be offered as services via a cloud environment. FIG. 7 is a simplified block diagram of a cloud-based system environment in which various services may be offered as cloud services in accordance with certain examples. In the example depicted in FIG. 5, cloud infrastructure system 502 may provide one or more cloud services that may be requested by users using one or more client computing devices 504, 506, and 508. Cloud infrastructure system 502 may comprise one or more computers and/or servers that may include those described above for server 412. The computers in cloud infrastructure system 502 may be organized as general purpose computers, specialized server computers, server farms, server clusters, or any other appropriate arrangement and/or combination.

Network(s) 510 may facilitate communication and exchange of data between clients 504, 506, and 508 and cloud infrastructure system 502. Network(s) 510 may include one or more networks. The networks may be of the same or different types. Network(s) 510 may support one or more communication protocols, including wired and/or wireless protocols, for facilitating the communications.

The example depicted in FIG. 5 is only one example of a cloud infrastructure system and is not intended to be limiting. It should be appreciated that, in some other examples, cloud infrastructure system 502 may have more or fewer components than those depicted in FIG. 5, may combine two or more components, or may have a different configuration or arrangement of components. For example, although FIG. 5 depicts three client computing devices, any number of client computing devices may be supported in alternative examples.

The term cloud service is generally used to refer to a service that is made available to users on demand and via a communication network such as the Internet by systems (e.g., cloud infrastructure system 502) of a service provider. Typically, in a public cloud environment, servers and systems that make up the cloud service provider's system are different from the customer's own on-premise servers and systems. The cloud service provider's systems are managed by the cloud service provider. Customers may thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, California, such as middleware services, database services, Java cloud services, and others.

In certain examples, cloud infrastructure system 502 may provide one or more cloud services using different models such as under a Software as a Service (SaaS) model, a Platform as a Service (PaaS) model, an Infrastructure as a Service (IaaS) model, and others, including hybrid service models. Cloud infrastructure system 502 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 502. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 502. Cloud infrastructure system 502 then performs processing to provide the services requested in the customer's subscription order. For example, a user may use utterances to request the cloud infrastructure system to take a certain action (e.g., provide a recommendation), and/or provide services for a machine-learning recommendation system as described herein. Cloud infrastructure system 502 may be configured to provide one or even multiple cloud services.

Cloud infrastructure system 502 may provide the cloud services via different deployment models. In a public cloud model, cloud infrastructure system 502 may be owned by a third party cloud services provider and the cloud services are offered to any general public customer, where the customer may be an individual or an enterprise. In certain other examples, under a private cloud model, cloud infrastructure system 502 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other examples, under a community cloud model, the cloud infrastructure system 502 and the services provided may be shared by several organizations in a related community. Various other models such as hybrids of the above mentioned models may also be used.

Client computing devices 504, 506, and 508 may be of different types (such as client computing devices 402, 404, 406, and 408 depicted in FIG. 4) and may be capable of operating one or more client applications. A user may use a client device to interact with cloud infrastructure system 502, such as to request a service provided by cloud infrastructure system 502. For example, a user may use a client device to request information or action from a machine-learning recommendation system as described in this disclosure.

In some examples, the processing performed by cloud infrastructure system 502 for providing services may involve model training and deployment. This analysis may involve using, analyzing, and manipulating data sets to train and deploy one or more models. This analysis may be performed by one or more processors, possibly processing the data in parallel, performing simulations using the data, and the like. For example, big data analysis may be performed by cloud infrastructure system 502 for generating and training one or more models for a machine-learning recommendation system. The data used for this analysis may include structured data (e.g., data stored in a database or structured according to a structured model) and/or unstructured data (e.g., data blobs (binary large objects)).

As depicted in the example in FIG. 5, cloud infrastructure system 502 may include infrastructure resources 530 that are utilized for facilitating the provision of various cloud services offered by cloud infrastructure system 502. Infrastructure resources 530 may include, for example, processing resources, storage or memory resources, networking resources, and the like. In certain examples, the storage virtual machines that are available for servicing storage requested from applications may be part of cloud infrastructure system 502. In other examples, the storage virtual machines may be part of different systems.

In certain examples, to facilitate efficient provisioning of these resources for supporting the various cloud services provided by cloud infrastructure system 502 for different customers, the resources may be bundled into sets of resources or resource modules (also referred to as “pods”). Each resource module or pod may comprise a pre-integrated and optimized combination of resources of one or more types. In certain examples, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 502 may itself internally use services 532 that are shared by different components of cloud infrastructure system 502 and which facilitate the provisioning of services by cloud infrastructure system 502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 502 may comprise multiple subsystems. These subsystems may be implemented in software, or hardware, or combinations thereof. As depicted in FIG. 5, the subsystems may include a user interface subsystem 512 that enables users or customers of cloud infrastructure system 502 to interact with cloud infrastructure system 502. User interface subsystem 512 may include various different interfaces such as a web interface 514, an online store interface 516 where cloud services provided by cloud infrastructure system 502 are advertised and are purchasable by a consumer, and other interfaces 518. For example, a customer may, using a client device, request (service request 534) one or more services provided by cloud infrastructure system 502 using one or more of interfaces 514, 516, and 518. For example, a customer may access the online store, browse cloud services offered by cloud infrastructure system 502, and place a subscription order for one or more services offered by cloud infrastructure system 502 that the customer wishes to subscribe to. The service request may include information identifying the customer and one or more services that the customer desires to subscribe to. For example, a customer may place a subscription order for a service offered by cloud infrastructure system 502. As part of the order, the customer may provide information identifying a machine-learning recommendation system for which the service is to be provided and optionally one or more credentials for the machine-learning recommendation system.

In certain examples, such as the example depicted in FIG. 5, cloud infrastructure system 502 may comprise an order management subsystem (OMS) 520 that is configured to process the new order. As part of this processing, OMS 520 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 520 may then invoke the order provisioning subsystem (OPS) 524 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

In certain examples, setup phase processing, as described above, may be performed by cloud infrastructure system 502 as part of the provisioning process. Cloud infrastructure system 502 may generate an application ID and select a storage virtual machine for an application from among storage virtual machines provided by cloud infrastructure system 502 itself or from storage virtual machines provided by other systems other than cloud infrastructure system 502.

Cloud infrastructure system 502 may send a response or notification 544 to the requesting customer to indicate when the requested service is now ready for use. In some instances, information (e.g., a link) may be sent to the customer that enables the customer to start using and availing the benefits of the requested services. In certain examples, for a customer requesting the service, the response may include a machine-learning recommendation system ID generated by cloud infrastructure system 502 and information identifying a machine-learning recommendation system selected by cloud infrastructure system 502 for the machine-learning recommendation system corresponding to the machine-learning recommendation system ID.

Cloud infrastructure system 502 may provide services to multiple customers. For each customer, cloud infrastructure system 502 is responsible for managing information related to one or more subscription orders received from the customer, maintaining customer data related to the orders, and providing the requested services to the customer. Cloud infrastructure system 502 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 502 may provide services to multiple customers in parallel. Cloud infrastructure system 502 may store information for these customers, including possibly proprietary information. In certain examples, cloud infrastructure system 502 comprises an identity management subsystem (IMS) 528 that is configured to manage customer information and provide the separation of the managed information such that information related to one customer is not accessible by another customer. IMS 528 may be configured to provide various security-related services such as identity services, such as information access management, authentication and authorization services, services for managing customer identities and roles and related capabilities, and the like.

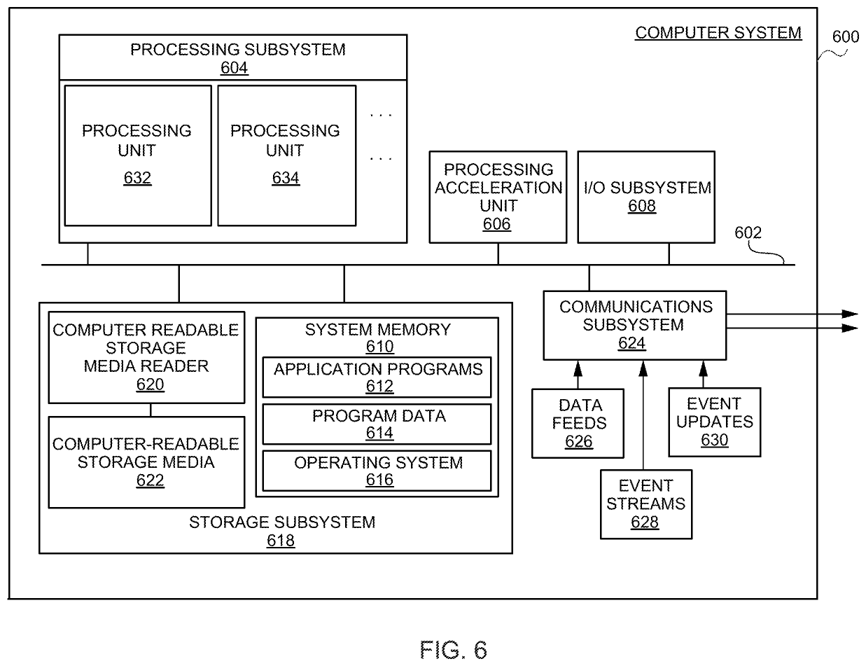

FIG. 6 illustrates an example of computer system 600. In some examples, computer system 600 may be used to implement any of the machine-learning recommendation systems within a distributed environment, and various servers and computer systems described above. As shown in FIG. 6, computer system 600 includes various subsystems including a processing subsystem 604 that communicates with a number of other subsystems via a bus subsystem 602. These other subsystems may include a processing acceleration unit 606, an I/O subsystem 608, a storage subsystem 618, and a communications subsystem 624. Storage subsystem 618 may include non-transitory computer-readable storage media including storage media 622 and a system memory 610.

Bus subsystem 602 provides a mechanism for letting the various components and subsystems of computer system 600 communicate with each other as intended. Although bus subsystem 602 is shown schematically as a single bus, alternative examples of the bus subsystem may utilize multiple buses. Bus subsystem 602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 604 controls the operation of computer system 600 and may comprise one or more processors, application specific integrated circuits (ASICs), or field programmable gate arrays (FPGAs). The processors may include be single core or multicore processors. The processing resources of computer system 600 may be organized into one or more processing units 632, 634, etc. A processing unit may include one or more processors, one or more cores from the same or different processors, a combination of cores and processors, or other combinations of cores and processors. In some examples, processing subsystem 604 may include one or more special purpose co-processors such as graphics processors, digital signal processors (DSPs), or the like. In some examples, some or all of the processing units of processing subsystem may be implemented using customized circuits, such as application specific integrated circuits (ASICs), or field programmable gate arrays (FPGAs).

In some examples, the processing units in processing subsystem 604 may execute instructions stored in system memory 610 or on computer readable storage media 622. In various examples, the processing units may execute a variety of programs or code instructions and may maintain multiple concurrently executing programs or processes. At any given time, some or all of the program code to be executed may be resident in system memory 610 and/or on computer-readable storage media 622 including potentially on one or more storage devices. Through suitable programming, processing subsystem 604 may provide various functionalities described above. In instances where computer system 600 is executing one or more virtual machines, one or more processing units may be allocated to each virtual machine.

In certain examples, a processing acceleration unit 606 may optionally be provided for performing customized processing or for off-loading some of the processing performed by processing subsystem 604 so as to accelerate the overall processing performed by computer system 600.

I/O subsystem 608 may include devices and mechanisms for inputting information to computer system 600 and/or for outputting information from or via computer system 600. In general, use of the term input device is intended to include all possible types of devices and mechanisms for inputting information to computer system 600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 600 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 618 provides a repository or data store for storing information and data that is used by computer system 600. Storage subsystem 618 provides a tangible non-transitory computer-readable storage medium for storing the basic programming and data constructs that provide the functionality of some examples. Storage subsystem 618 may store software (e.g., programs, code modules, instructions) that when executed by processing subsystem 604 provides the functionality described above. The software may be executed by one or more processing units of processing subsystem 604. Storage subsystem 618 may also provide authentication in accordance with the teachings of this disclosure.

Storage subsystem 618 may include one or more non-transitory memory devices, including volatile and non-volatile memory devices. As shown in FIG. 6, storage subsystem 618 includes a system memory 610 and a computer-readable storage media 622. System memory 610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 600, such as during start-up, may typically be stored in the ROM. The RAM typically contains data and/or program modules that are presently being operated and executed by processing subsystem 604. In some implementations, system memory 610 may include multiple different types of memory, such as static random access memory (SRAM), dynamic random access memory (DRAM), and the like.

By way of example, and not limitation, as depicted in FIG. 6, system memory 610 may load application programs 612 that are being executed, which may include various applications such as Web browsers, mid-tier applications, relational database management systems (RDBMS), etc., program data 614, and an operating system 616. By way of example, operating system 616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 622 may store programming and data constructs that provide the functionality of some examples. Computer-readable media 622 may provide storage of computer-readable instructions, data structures, program modules, and other data for computer system 600. Software (programs, code modules, instructions) that, when executed by processing subsystem 604 provides the functionality described above, may be stored in storage subsystem 618. By way of example, computer-readable storage media 622 may include non-volatile memory such as a hard disk drive, a magnetic disk drive, an optical disk drive such as a CD ROM, DVD, a Blu-Ray® disk, or other optical media. Computer-readable storage media 622 may include, but is not limited to, Zip® drives, flash memory cards, universal serial bus (USB) flash drives, secure digital (SD) cards, DVD disks, digital video tape, and the like. Computer-readable storage media 622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 618 may also include a computer-readable storage media reader 620 that may further be connected to computer-readable storage media 622. Reader 620 may receive and be configured to read data from a memory device such as a disk, a flash drive, etc.

In certain examples, computer system 600 may support virtualization technologies, including but not limited to virtualization of processing and memory resources. For example, computer system 600 may provide support for executing one or more virtual machines. In certain examples, computer system 600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 600. Accordingly, multiple operating systems may potentially be run concurrently by computer system 600.

Communications subsystem 624 provides an interface to other computer systems and networks. Communications subsystem 624 serves as an interface for receiving data from and transmitting data to other systems from computer system 600. For example, communications subsystem 624 may enable computer system 600 to establish a communication channel to one or more client devices via the Internet for receiving and sending information from and to the client devices. For example, when computer system 600 is used to implement machine-learning recommendation system 100 depicted in FIG. 1, the communication subsystem may be used to communicate with a machine-learning recommendation system selected for an application.

Communication subsystem 624 may support both wired and/or wireless communication protocols. In certain examples, communications subsystem 624 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 602.XX family standards, or other mobile communication technologies, or any combination thereof), global positioning system (GPS) receiver components, and/or other components. In some examples, communications subsystem 624 may provide wired network connectivity (e.g., Ethernet) in addition to or instead of a wireless interface.

Communication subsystem 624 may receive and transmit data in various forms. In some examples, in addition to other forms, communications subsystem 624 may receive input communications in the form of structured and/or unstructured data feeds 626, event streams 628, event updates 630, and the like. For example, communications subsystem 624 may be configured to receive (or send) data feeds 626 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 624 may be configured to receive data in the form of continuous data streams, which may include event streams 628 of real-time events and/or event updates 630, which may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 624 may also be configured to communicate data from computer system 600 to other computer systems or networks. The data may be communicated in various different forms such as structured and/or unstructured data feeds 626, event streams 628, event updates 630, and the like to one or more databases that may be in communication with one or more streaming data source computers coupled to computer system 600.

Computer system 600 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 600 depicted in FIG. 6 is intended only as a specific example. Many other configurations having more or fewer components than the system depicted in FIG. 6 are possible. Based on the disclosure and teachings provided herein, it should be appreciate there are other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, components or modules are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed:

1. A method comprising:
obtaining historical data comprising user profiles, a list of products and their associated characteristics, and transactional data pertaining to users associated with the user profiles and the products;
training a machine-learning model using the historical data, wherein: the machine-learning model comprises one or more algorithms configured to model a game between a first player and a second player, the first player represents a first party associated with the users and the second player represents a second party associated with a stakeholder in the products, and the training comprises:
inputting the historical data into the machine-learning model;
playing the game between the first player and the second player, wherein the game is played using a minmax theorem to minimize a worst-case potential loss that is evaluated with a loss function comprising a first component that represents error in a prediction of a user and product combination and a second component that represents error in a prediction of a value of a product, and the playing comprises performing iteratively the following until an equilibrium point is reached:
the first player chooses a strategy for recommending a product that is evaluated based on the loss function, wherein, for the strategy of the first player, the first player will try to recommend the product based on user choice using a collaborative filtering approach, and the objective of the first player is to minimize an error between the prediction of the user and the product combination and an actual user and product combination;
the second player chooses a strategy for recommending a product that is evaluated based on the loss function, wherein, for the strategy of the second player, the second player will try to recommend a product based on a value that the second party may gain by selling the product, and the objective of the second player is to recommend a higher value product; and
determining whether an equilibrium point has been reached; and
in response to reaching the equilibrium point, determining a final value corresponding to a product to be recommended for the first party and adapting the machine-learning model to minimize the difference between the final value and ground truth information and obtain a trained machine-learning model; and
providing the trained machine-learning model.

2. The method of claim 1, wherein the adapting the machine-learning model comprises updating model parameters of the machine-learning model.

3. The method of claim 2, wherein the providing comprises deploying the trained machine-learning model with the updated model parameters in a real-world environment.

4. The method of claim 3, further comprising:
receiving a user profile of a first party and a list of products and their characteristics associated with a second party;
inputting the user profile and the list of products and their characteristics into the trained machine-learning model;
predicting, by the trained machine-learning model, a product to be recommend for the first party based on the user profile and the list of products and their characteristics; and
recommending the product to the first party.

5. The method of claim 1, wherein the collaborative filtering approach comprises:
mapping the transactional data to implicit ratings for the products using an algorithm; and
inputting the historical data and the implicit ratings into a collaborative filter, which uses similarities between the users and the products to provide recommendations.

6. The method of claim 5, wherein the collaborative filtering is performed on the loss function using a matrix factorization first party vector and a matrix factorization product vector, and the loss function calculates the error between the prediction of the user and the product combination and the actual user and product combination from the matrix factorization.

7. The method of claim 6, wherein the loss function is:
$${l}_{0} = {\sum }_{{u}_{i} ∈ S} {( {r}_{{u}_{i}} - {x}_{u}^{T} )}^{2} + {λ}_{x} {\sum }_{u} {‖ {x}_{u} ‖}^{2} + {λ}_{y} {\sum }_{u} {‖ {y}_{i} ‖}^{2} - \frac{{λ}_{c}}{2} {\sum }_{i} {‖ {C}_{i} ‖}^{2}$$
where the rᵤᵢ is the rating of the first party u along with corresponding product i, xᵤ is the matrix factorization first party vector, yᵢ is the matrix factorization product vector, λₓ, λ_{y} is regularization parameters, the Cᵢ is the value that the second party may gain by selling the corresponding product i, λ_{c} is a regularization coefficient.

8. A system comprising:
one or more processors; and
a memory coupled to the one or more processors, the memory storing a plurality of instructions executable by the one or more processors, the plurality of instructions comprising instructions that when executed by the one or more processors cause the one or more processors to perform the following operations:
obtaining historical data comprising user profiles, a list of products and their associated characteristics, and transactional data pertaining to users associated with the user profiles and the products;
training a machine-learning model using the historical data, wherein: the machine-learning model comprises one or more algorithms configured to model a game between a first player and a second player, the first player represents a first party associated with the users and the second player represents a second party associated with a stakeholder in the products, and the training comprises:
inputting the historical data into the machine-learning model;
playing the game between the first player and the second player, wherein the game is played using a minmax theorem to minimize a worst-case potential loss that is evaluated with a loss function comprising a first component that represents error in a prediction of a user and product combination and a second component that represents error in a prediction of a value of a product, and the playing comprises performing iteratively the following until an equilibrium point is reached:
the first player chooses a strategy for recommending a product that is evaluated based on the loss function, wherein, for the strategy of the first player, the first player will try to recommend the product based on user choice using a collaborative filtering approach, and the objective of the first player is to minimize an error between the prediction of the user and the product combination and an actual user and product combination;
the second player chooses a strategy for recommending a product that is evaluated based on the loss function, wherein, for the strategy of the second player, the second player will try to recommend a product based on a value that the second party may gain by selling the product, and the objective of the second player is to recommend a higher value product; and
determining whether an equilibrium point has been reached; and
in response to reaching the equilibrium point, determining a final value corresponding to a product to be recommended for the first party and adapting the machine-learning model to minimize the difference between the final value and ground truth information and obtain a trained machine-learning model; and
providing the trained machine-learning model.

9. The system of claim 8, wherein the adapting the machine-learning model comprises updating model parameters of the machine-learning model.

10. The system of claim 9, wherein the providing comprises deploying the trained machine-learning model with the updated model parameters in a real-world environment.

11. The system of claim 10, wherein the operations further comprise:
receiving a user profile of a first party and a list of products and their characteristics associated with a second party;
inputting the user profile and the list of products and their characteristics into the trained machine-learning model;
predicting, by the trained machine-learning model, a product to be recommend for the first party based on the user profile and the list of products and their characteristics; and
recommending the product to the first party.

12. The system of claim 8, wherein the collaborative filtering approach comprises:
mapping the transactional data to implicit ratings for the products using an algorithm; and
inputting the historical data and the implicit ratings into a collaborative filter, which uses similarities between the users and the products to provide recommendations.

13. The system of claim 12, wherein the collaborative filtering is performed on the loss function using a matrix factorization first party vector and a matrix factorization product vector, and the loss function calculates the error between the prediction of the user and the product combination and the actual user and product combination from the matrix factorization.

14. The system of claim 13, wherein the loss function is:
$${l}_{0} = {\sum }_{{u}_{i} ∈ S} {( {r}_{{u}_{i}} - {x}_{u}^{T} )}^{2} + {λ}_{x} {\sum }_{u} {‖ {x}_{u} ‖}^{2} + {λ}_{y} {\sum }_{u} {‖ {y}_{i} ‖}^{2} - \frac{{λ}_{c}}{2} {\sum }_{i} {‖ {C}_{i} ‖}^{2}$$
where the rᵤᵢ is the rating of the first party u along with corresponding product i, xᵤ is the matrix factorization first party vector, yᵢ is the matrix factorization product vector, λₓ, λ_{y} is regularization parameters, the Cᵢ is the value that the second party may gain by selling the corresponding product i, λ_{c} is a regularization coefficient.

15. A non-transitory computer-readable memory storing a plurality of instructions executable by one or more processors, the plurality of instructions comprising instructions that when executed by the one or more processors cause the one or more processors to perform the following operations:
obtaining historical data comprising user profiles, a list of products and their associated characteristics, and transactional data pertaining to users associated with the user profiles and the products;
training a machine-learning model using the historical data, wherein: the machine-learning model comprises one or more algorithms configured to model a game between a first player and a second player, the first player represents a first party associated with the users and the second player represents a second party associated with a stakeholder in the products, and the training comprises:
inputting the historical data into the machine-learning model;
playing the game between the first player and the second player, wherein the game is played using a minmax theorem to minimize a worst-case potential loss that is evaluated with a loss function comprising a first component that represents error in a prediction of a user and product combination and a second component that represents error in a prediction of a value of a product, and the playing comprises performing iteratively the following until an equilibrium point is reached:
the first player chooses a strategy for recommending a product that is evaluated based on the loss function, wherein, for the strategy of the first player, the first player will try to recommend the product based on user choice using a collaborative filtering approach, and the objective of the first player is to minimize an error between the prediction of the user and the product combination and an actual user and product combination;
the second player chooses a strategy for recommending a product that is evaluated based on the loss function, wherein, for the strategy of the second player, the second player will try to recommend a product based on a value that the second party may gain by selling the product, and the objective of the second player is to recommend a higher value product; and
determining whether an equilibrium point has been reached; and
in response to reaching the equilibrium point, determining a final value corresponding to a product to be recommended for the first party and adapting the machine-learning model to minimize the difference between the final value and ground truth information and obtain a trained machine-learning model; and
providing the trained machine-learning model.

16. The non-transitory computer-readable memory of claim 15, wherein the adapting the machine-learning model comprises updating model parameters of the machine-learning model.

17. The non-transitory computer-readable memory of claim 16, wherein the providing comprises deploying the trained machine-learning model with the updated model parameters in a real-world environment.

18. The non-transitory computer-readable memory of claim 17, wherein the operations further comprise:
receiving a user profile of a first party and a list of products and their characteristics associated with a second party;
inputting the user profile and the list of products and their characteristics into the trained machine-learning model;
predicting, by the trained machine-learning model, a product to be recommend for the first party based on the user profile and the list of products and their characteristics; and
recommending the product to the first party.

19. The non-transitory computer-readable memory of claim 15, wherein the collaborative filtering approach comprises:
mapping the transactional data to implicit ratings for the products using an algorithm; and
inputting the historical data and the implicit ratings into a collaborative filter, which uses similarities between the users and the products to provide recommendations.

20. The non-transitory computer-readable memory of claim 19, wherein the collaborative filtering is performed on the loss function using a matrix factorization first party vector and a matrix factorization product vector, and the loss function calculates the error between the prediction of the user and the product combination and the actual user and product combination from the matrix factorization.
